(19) United States
(12) Patent Application Publication
(10) Pub. No.: US 2020/0075953 A1
(43) Pub. Date: Mar. 5, 2020

(54) LEAD CARBON BATTERY COMPRISING AN ACTIVATED CARBON ANODE

(71) Applicant: TEEBS R&D, LLC, Malvern, PA (US)

(72) Inventors: Eran Turi, Richboro, PA (US); Trevor Beard, Norristown, PA (US); Brett Kilhenny, Mystic, CT (US); Wei Wang, Waltham, MA (US)

(21) Appl. No.: 16/675,408

(22) Filed: Nov. 6, 2019

Related U.S. Application Data
(63) Continuation-in-part of application No. 16/404,858, filed on May 7, 2019.
(60) Provisional application No. 62/667,799, filed on May 7, 2018.

(51) Int. Cl. H01M 4/583; H01M 4/56; H01M 4/62; H01M 10/20

(52) U.S. Cl. CPC H01M 4/583; H01M 4/56; H01M 2004/021; H01M 10/20; H01M 4/625; H01M 4/623

(57) ABSTRACT

A lead carbon battery includes an activated carbon anode comprising the active layer and a current collector, wherein the active layer is in electrical contact with the current collector; a lead oxide cathode that is in electrical contact with a cathode side current collector; an acid located in between the activated carbon anode and the cathode; and a casing encapsulating the activated carbon anode, the cathode, and the acid wherein the active layer includes greater than or equal to 85 weight percent of the activated carbon, 1 to 15 weight percent of a fibrillated poly(vinylidene fluoride), and 0 to 10 weight percent of an electrically conductive filler.

### CROSS-REFERENCE TO RELATED APPLICATION

This application is a continuation-in-part of U.S. application Ser. No. 16/404,858 filed May 7, 2019, which claims the benefit of U.S. Provisional Application No. 62/667,799 filed on May 7, 2018. The related applications are incorporated herein in their entirety by reference.

### BACKGROUND

Conventional, commercial lead acid batteries rely on negative electrodes (anodes) that are composed of lead metal and positive electrodes (cathodes) that are composed of lead dioxide to generate an electric current. The limitations of lead acid batteries include difficulties in achieving a high number of charge-discharge cycles and a deterioration of rate capability. While both the anode and cathode contribute to these limitations, the lead metal anode is susceptible to incomplete charging as a certain amount is lost in the replating process, causing a loss in battery capacity. In addition, the structure of the anode changes, which usually results in less integrity and connectedness that causes additional losses in rate capability.

These issues are further exacerbated in batteries constructed of bipolar electrodes that have a lead foil current collector with an anode electrode coating on one side of the foil and a cathode electrode coating on the opposite side. Bipolar electrodes are designed for high rate operation as is often required for use in automotive applications. Since both electrode coatings can utilize the same current collector, the incomplete charging of the lead metal anode affects the mechanical properties of the cathode electrode on the opposite side of the foil. Also, the loss in connectedness with the resulting loss in rate capability limits the current that is available to the cathode, even without any cathode electrode degradation.

In order to overcome these issues, anodes comprising an activated carbon have been developed, both with and without the presence of lead. These activated carbon anodes can take advantage of a dual Faradic-Capacitance phenomena, whereby the activated carbon acts to produce a charge separation that can absorb high current influx at the instant of a high rate charge. This absorption in the high current influx has been shown to result in a reduction in the wear that is often associated with a repeatedly applied high current influx on the anode. Unfortunately though, the prior activated carbon anodes have not been shown as being capable of achieving the desired high storage capabilities.

Accordingly, there remains a need in the art for an anode comprising an activated carbon electrode that is capable of achieving improved storage capabilities.

### BRIEF SUMMARY

Disclosed herein is a method of forming a carbon based active layer for an anode of a lead carbon battery and the active layer formed therefrom.

In an aspect, a method of making an active layer for an activated carbon anode in a lead carbon battery comprises forming a solvent mixture comprising poly(vinylidene fluoride), an optional electrically conductive filler, and a solvent; combining the solvent mixture with a non-solvent to form a precipitate comprising the activated carbon in a fibrillated poly(vinylidene fluoride) matrix; wherein at least one of the solvent mixture and the non-solvent comprises the activated carbon; separating the precipitate from the solvent and the non-solvent; and forming the active layer from the precipitate. The active layer comprises greater than or equal to 85 weight percent of the activated carbon; 1 to 15 weight percent of the fibrillated poly(vinylidene fluoride); and 0 to 10 weight percent of an electrically conductive filler; wherein the weights are based on the total weight of the active layer.

In another aspect, an active layer is formed by the method.

In yet another aspect, a lead carbon battery comprises an activated carbon anode comprising the active layer and a current collector, wherein the active layer is in electrical contact with the current collector; a lead oxide cathode that is in electrical contact with a cathode side current collector; an acid located in between the activated carbon anode and the cathode; and a casing encapsulating the activated carbon anode, the cathode, and the acid.

In yet another aspect, A lead carbon battery comprises an activated carbon anode comprising an active layer; a current collector, wherein the active layer is in electrical contact with the current collector; a lead oxide cathode that is in electrical contact with a cathode side current collector; an acid located in between the activated carbon anode and the cathode; and a casing encapsulating the activated carbon anode, the cathode, and the acid; wherein the active layer comprises greater than or equal to 85 weight percent of the activated carbon; 1 to 15 weight percent of the fibrillated poly(vinylidene fluoride); and 0 to 10 weight percent of an electrically conductive filler; wherein the weights are based on the total weight of the active layer; wherein the active layer has a porosity of 30 to 75 volume percent.

The above described and other features are exemplified by the following figures, detailed description, and claims.

### BRIEF DESCRIPTION OF THE DRAWINGS

The following figures are exemplary aspect, which are provided to illustrate the present disclosure. At least one of the figures is illustrative of the examples, which are not intended to limit devices made in accordance with the disclosure to the materials, conditions, or process parameters set forth herein.

FIG. 1 is an illustration of a lead carbon battery;

FIG. 2 is an illustration of an activated carbon anode;

FIG. 3 is a scanning electron microscopy (SEM) image of an active layer;

FIG. 4 is a scanning electron microscopy (SEM) image of an active layer;

FIG. 5 is a graphical illustration of the discharge capacity versus porosity of Example 2;

FIG. 6 is a graphical illustration of the power versus discharged capacity of Examples 7 and 8;

FIG. 7 is a graphical illustration of the power versus discharged capacity with increasing cycles of Example 8;

FIG. 8 is a graphical illustration of the power versus discharged capacity of with increasing cycles of Example 7; and

FIG. 9 is a graphical illustration of the capacity retention with cycling of Examples 7 and 8.

### DETAILED DESCRIPTION

A method of making an active layer comprising an activated carbon for use in an anode (referred an activated carbon anode) in a lead carbon battery (where the anode comprises the activated carbon anode) was developed. The method comprises forming a solvent mixture comprising poly(vinylidene fluoride), an activated carbon, an optional electrically conductive filler, and a solvent; combining the solvent mixture with a non-solvent to form a precipitate comprising the activated carbon in a fibrillated poly(vinylidene fluoride) matrix; separating the precipitate from the solvent and the non-solvent; and forming the active layer from the precipitate. The active layer can comprise greater than or equal to 85 weight percent of the activated carbon; 1 to 15 weight percent of the fibrillated poly(vinylidene fluoride); and 0 to 10 weight percent of an electrically conductive filler; wherein the weights are based on the total weight of the active layer. It was surprisingly discovered that merely by using the present method, an improved active layer could be prepared resulting in significant improvements in lead carbon battery performance. Without being bound by theory, it is believed that these improvements arise from the different morphology of the present active layer as compared to active layers prepared by different methods, including a higher proportion of exposed surface area of the activated carbon or a multiscale porosity. It is further believed that presence the poly(vinylidene fluoride) fibrils acts as a matrix stabilizer imposing various stresses on the activated particles to maintain the structural integrity of the active layer, thereby allowing it to be a free standing layer. For example, the fibrils can thread through the activated particles to maintain their interconnectedness.

A lead carbon battery that includes the activated carbon anode can result in at least one of an improved specific capacity (the amount of charge stored per unit mass) or an improved rate capability (the power out, dynamic charge acceptance). The high specific capacity of the activated carbon anode can provide an abundant source of reducing agents that can help to retard the corrosion of the current collector, which can ultimately extend the battery life. It can also help to maintain a low interfacial resistance between the current collector and the active layer in the activated carbon anode to preserve high power battery performance. Furthermore, the reduction in lead content by replacing the lead active layer with the present active layer can result in material cost savings or battery recycling advantages. Ultimately, these improvements can offer a performance advantage for many lead acid battery applications, especially for applications in automotive platforms, such as starting-lighting-ignition for internal combustion engines, power leveling for hybrid electric vehicle drive systems, or industrial electric vehicles.

This improved active material provides a timely means of creating a lead carbon battery that can exceed the performance of conventional lead acid batteries and also that of prior lead carbon batteries. For example, a lead carbon battery including the activated carbon anode can compete with lithium ion based and nickel metal hydride based battery chemistries that are presently positioned for use in start-stop automotive and in 48 volt mild hybrid electric vehicle systems and similar automotive platforms.

The present method comprises forming a solvent mixture comprising poly(vinylidene fluoride), optionally the activated carbon, the optional electrically conductive filler, and the solvent. The solvent mixture can be formed by mixing the poly(vinylidene fluoride), the activated carbon, and the optional electrically conductive filler with the solvent to dissolve the poly(vinylidene fluoride) and form the solvent mixture. The solvent mixture can be formed by dissolving poly(vinylidene fluoride) in a solvent and then adding the activated carbon and the optional electrically conductive filler to form the solvent mixture. The solvent mixture The solvent mixture can be formed by dissolving poly(vinylidene fluoride) in a solvent and the activated carbon could be mixed with the non-solvent.

As is easily determined by those of ordinary skill in the art, the solvent mixture can comprise a sufficient amount of the solvent to dissolve the poly(vinylidene fluoride). Forming the solvent mixture can comprising mixing for a sufficient amount of time to dissolve the poly(vinylidene fluoride) that can range from minutes to hours depending on the intensity of the mixing and the relative amounts of the solvent and the poly(vinylidene fluoride). The solvent mixture can be mixed until a slurry is formed, where the activated carbon and the optional electrically conductive filler are suspended in the solvent mixture. One or more of the mixing steps can comprise ultrasonically mixing.

The solvent mixture can comprise 85 to 98 weight percent (wt %), or 90 to 96 wt % of the activated carbon based on the total weight of the mixture minus the solvent. The solvent mixture can comprise 2 to 15 wt %, or 4 to 10 wt % of the poly(vinylidene fluoride) based on the total weight of the mixture minus the solvent. The solvent mixture can comprise 0 to 10 wt %, or 1 to 10 wt % of the electrically conductive filler based on the total weight of the mixture minus the solvent.

The solvent can have a δ_{d} Hansen solubility parameter of 15≤δ_{d}≤20 megapascalu^{1/2} (MPa)^{1/2}, or 16≤δ_{d}≤18.5 MPa^{1/2}. The solvent can have a δₚ Hansen solubility parameter of 5≤δₚ≤18 MPa^{1/2}, or 8.5≤δₚ≤16.5 MPa^{1/2}. The solvent can have a δₕ Hansen solubility parameter of or 4≤δₕ≤12 MPa^{1/2}, or 5≤δₕ≤11.5 MPa^{1/2}. The solvent can comprise at least one of acetone, cyclohexanone, dinmethylacetamride (DMAc), methyl ethyl ketone, N,N-dimethylfonnamide (DMF), dimethyl sulfoxide (DMSO), N-methylpyrrolidone (NMP), tetrahydrofuran (THF), tetramethyl urea, or trimethyl phosphate. Preferably, the solvent comprises at least one of dimethylacetanide (DMAc), methyl ethyl ketone, N,N-dimethylformamide (DMF), N-methylpyrrolidone (NMP), or dimethyl sulfoxide (DMSO).

After forming the solvent mixture, the solvent mixture is combined with a non-solvent to form a precipitate comprising the activated carbon and optional electrically conductive filler in a fibrillated poly(vinylidene fluoride) matrix. It is noted that after combining with the non-solvent, the precipitate is not in the form of a layer and could instead be considered as being particulate. The combining with the non-solvent results in a phase inversion of the poly(vinylidene fluoride) dissolved in the solvent to a precipitated poly(vinylidene fluoride) present in the non-solvent, as the solvent diffuses out of the solvent mixture. The combining can comprise injecting the solvent mixture via an injection nozzle into the non-solvent to induce a shear on the solvent mixture during the combining. The combining can comprise mixing during the combining to induce a shear on the solvent mixture. The application of a shear can facilitate the fibrillation of the poly(vinylidene fluoride). The combining the solvent mixture with the non-solvent can occur without actively mixing the solvent mixture with the non-solvent, for example, at least one of the solvent mixture or the non-solvent can be merely added (for example, poured or injected or otherwise) to the other of the solvent mixture or the non-solvent without an active mixing (for example, without stirring from a stir bar).

The non-solvent can have a δ_{d} Hansen solubility parameter of 12≤δ_{d}≤14.9 MPa^{1/2}. The non-solvent can have a δₚ Hansen solubility parameter of 0≤δₚ≤8 MPa^{1/2}, or 1≤δₚ≤4.9 MPa^{1/2}. The non-solvent can have a δₕ Hansen solubility parameter of or 13≤δₕ≤50 MPa^{1/2}, or 15≤δₕ≤45 MPa^{1/2}. The non-solvent can comprise at least one of an acid solution, an alcohol (for example, an alkyl alcohol such as a CI-s alkanol), an aliphatic hydrocarbon, an aromatic hydrocarbon, a basic solution, butyrolactone, N-butyl acetate, carbitol acetate, diisobutyl ketone, dimethyl phthalate, ethyl acetoacetate, a glycol ether, a glycol ether ester, glyceryl triacetate, a halogenated solvent, isophorone, methyl isobutyl ketone, propylene carbonate, triethyl phosphate, or water. The non-solvent can be present in excess of the solvent. For example, a ratio of the non-solvent to the solvent can be 2:1 to 1,000:1, or 10:1 to 500:1.

The precipitate can then be separated from the solvent and the non-solvent. The separating can comprise at least one of draining, filtering, or centrifuging the solvent and the non-solvent from the precipitate.

The separated precipitate can then be formed into an active layer. The active layer can be formed by depositing the precipitate onto a substrate (for example, a flat substrate) and drying the precipitate to remove the remaining solvent and non-solvent. Forming the active layer can comprise at least one of thermoforming, calendering, laminating, or roll coating. Forming the active layer can comprise at least one of extruding, molding, casting, thermoforming, calendaring, laminating, or roll coating. For example, the precipitate can be extruded, dried, and then calendered to form the active layer.

The active layer can have of a porosity of 30 to 75 volume percent, or 40 to 75 volume percent, or 50 to 75 volume percent, or 40 to 70 volume percent as calculated based on a total volume of the active layer. The active layer can have a combination of macropores (having an average pore size of on the micrometer length scale), mesopores (having a pore size of 2 to 50 nanometers), and micropores (having a pore size of less than 2 nanometers). The active layer can be compressed, for example by calendering to reduce the porosity. The reduced porosity can be 25 to 50 volume percent based on a total volume of the active layer.

The active layer can have a thickness of 0.01 to 10 millimeters, or 0.1 to 8 millimeters. The active layer can have an increased thickness of greater than or equal to 0.5 millimeters, or 0.5 to 10 millimeters, or 1 to 5 millimeters, or 1.5 to 2.5 millimeters, or 2.5 to 5 millimeters. The ability to form an active layer material comprising poly(vinylidene fluoride) and an activated carbon having these increased thicknesses has been challenging, but is formed with ease using the present method. The increased thickness of the present active layer can allow for the active layer to be free standing in that it does not need to be supported by a support in order to maintain their structural integrity. This feature can allow for easier handling and processing of the active layer material.

The poly(vinylidene fluoride) can comprise at least one of a poly(vinylidene fluoride) homopolymer or a poly(vinylidene fluoride) copolymer. The poly(vinylidene fluoride) copolymer can comprise repeat units derived from at least one of chlorotrifluoroethylene, tetrafluoroethylene (CF₂═CF₂), chlorotrifluoroethylene (CClF═CF₂), (perfluorobutyl)ethylene, hexafluoropropylene (CF₂═CFCF₃), ethylene, propylene, butene, or an ethylenically unsaturated aromatic monomer such as styrene or alpha-methyl-styrene. An example of a poly(vinylidene fluoride) is KYNAR 761 available from Arkema.

The activated carbon can have a surface area of greater than or equal to 500 meters squared per gram (m²/g), or greater than or equal to 1,500 m²/g, or 500 to 3,000 m²/g. The activated carbon can have a D₅₀ particles size by weight of 1 to 100 micrometers, or 1 to 50 micrometers, or 5 to 10 micrometers, or 15 to 50 micrometers. The activated carbon can have a multimodal particle size, for example, having a first mode that is at least 7 times greater than that of the second mode. For example, the first mode can have peak of greater than or equal to 7 or greater than or equal to 35 micrometers and the second mode can have a peak of less than or equal to 1 micrometer, or less than or equal to 5 micrometers. An example of an activated carbon is ELITE-C available from Calgon Carbon LLC, or POWDERED-S available from General Carbon Corporation.

The electrically conductive filler can be present and can result in a beneficial decrease in the voltage drop in the activated carbon anode, which can enable the resulting battery cell to operate at a high power with less conversion of energy to heat and can also increase the cell capacity over a given operating voltage range. The electrically conductive filler can comprise at least one of graphite, carbon nanotubes, carbon fibers, graphene, or carbon black. Examples of carbon black are SUPER-P from Imersys, VULCAN XC-72 from Cabot Corporation, and SHAWINIGAN BLACK from Chevron Corporation. Examples of carbon nanotubes are those commercially available from Showa Denko K.K. and Bayer AG.

The active layer can comprise 85 to 99 wt %, or 90 to 98 wt %, or 90 to 96 wt % of the activated carbon based on the total weight of the active layer. The active layer can comprise 1 to 15 wt %, or 2 to 10 wt %, or 4 to 10 wt % of the poly(vinylidene fluoride) based on the total weight of the active layer. A weight ratio of the activated carbon to the poly(vinylidene fluoride) can be greater than or equal to 8:1, or 9:1 to 50:1. The active layer can comprise 0 wt %, or 0 to 10 wt %, or 1 to 5 wt % of the electrically conductive filler based on the total weight of the active layer.

In an aspect, a method of making an active layer for an activated carbon anode in a lead carbon battery includes: forming a solvent mixture comprising poly(vinylidene fluoride), and at least one of acetone, cyclohexanone, dimethylacetamide, methyl ethyl ketone, N,N-dimethylformamide, dimethyl sulfoxide, N-methylpyrrolidone, tetrahydrofuran, tetramethyl urea, or trimethyl phosphate; combining the solvent mixture with a non-solvent, in particular at least one of an acid solution, an alcohol, an aliphatic hydrocarbon, an aromatic hydrocarbon, a basic solution, butyrolactone, N-butyl acetate, carbitol acetate, diisobutyl ketone, dimethyl phthalate, ethyl acetoacetate, a glycol ether, a glycol ether ester, glyceryl triacetate, a halogenated solvent, isophorone, methyl isobutyl ketone, propylene carbonate, triethyl phosphate, or water, to form a precipitate comprising the activated carbon having a surface area of greater than or equal to 500 m²/g, or greater than or equal to 1,500 m²/g, in a fibrillated poly(vinylidene fluoride) matrix; wherein at least one of the solvent mixture and the non-solvent comprise the activated carbon or an optional electrically conductive filler; separating the precipitate from the solvent and the non-solvent; and forming the active layer from the precipitate. Preferably in this aspect, the active layer comprises greater than or equal to 85 weight percent of the activated carbon; 1 to 15 weight percent of the fibrillated poly(vinylidene fluoride); and 0 to 10 weight percent of an electrically conductive filler; wherein the weights are based on the total weight of the active layer; and the active layer has a porosity of 30 to 75 volume percent and a thickness of 0.5 to 10 millimeters, or 2.5 to 5 millimeters. The active layer can be a freestanding layer.

In another aspect, a method of making an active layer for an activated carbon anode in a lead carbon battery includes: forming a solvent mixture comprising a poly(vinylidene fluoride) copolymer, most preferably a poly(vinylidene fluoride) copolymer with chlorotrifluoroethylene, and at least one of dimethylacetamide, methyl ethyl ketone, N,N-dimethylformamide, N-methylpyrrolidone, or dimethyl sulfoxide; combining the solvent mixture with a non-solvent, in particular at least one of an acid solution, an alcohol, an aliphatic hydrocarbon, an aromatic hydrocarbon, a basic solution, butyrolactone, N-butyl acetate, carbitol acetate, diisobutyl ketone, dimethyl phthalate, ethyl acetoacetate, a glycol ether, a glycol ether ester, glyceryl triacetate, a halogenated solvent, isophorone, methyl isobutyl ketone, propylene carbonate, triethyl phosphate, or water, to form a precipitate comprising the activated carbon having a surface area of greater than or equal to 500 m²/g, or greater than or equal to 1,500 m²/g, in a fibrillated poly(vinylidene fluoride) matrix; wherein at least one of the solvent mixture and the non-solvent comprise the activated carbon or an optional electrically conductive filler; separating the precipitate from the solvent and the non-solvent; and forming the active layer from the precipitate. Preferably in this aspect, the active layer comprises greater than or equal to 85 weight percent of the activated carbon; 1 to 15 weight percent of the fibrillated poly(vinylidene fluoride); and 0 to 10 weight percent of an electrically conductive filler; wherein the weights are based on the total weight of the active layer; and the active layer has a porosity of 30 to 75 volume percent and a thickness of 0.5 to 10 millimeters, or 2.5 to 5 millimeters. The active layer can be a freestanding layer.

The active layer can be used in an activated carbon anode of a lead carbon battery. The lead carbon battery can comprise an activated carbon anode comprising an active layer; a current collector, wherein the active layer is in electrical contact with the current collector; a lead oxide cathode that is in electrical contact with a cathode side current collector; an acid located in between the activated carbon anode and the cathode; and a casing encapsulating the activated carbon anode, the cathode, and the acid. The active layer can be formed by the disclosed method or another method such that it comprises greater than or equal to 85 weight percent of the activated carbon; 1 to 15 weight percent of the fibrillated poly(vinylidene fluoride); and 0 to 10 weight percent of an electrically conductive filler; wherein the weights are based on the total weight of the active layer; and has a porosity of 30 to 75 volume percent. Such a lead carbon battery can have at least one of a power of greater than 9 kilowatts after a 5 s charge and a 10 s discharge after discharging 2,000 watt hours of energy; or a capacity retention of over 90% after 5,000 cycles or over 80% after 10,000 cycles.

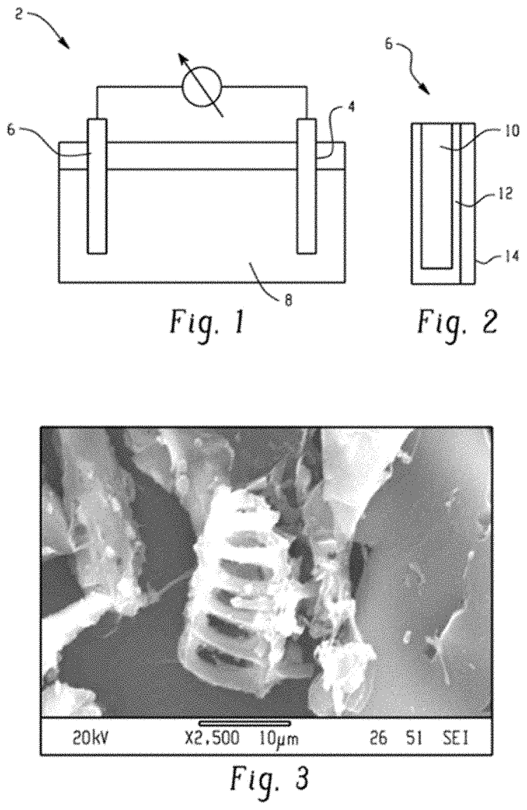

An example of a lead carbon battery is illustrated in FIG. 1. FIG. 1 shows that lead carbon battery 2 comprises a cathode 4 and an activated carbon anode 6. At least a portion of the electrodes is immersed in a medium 8 comprising sulfuric acid. FIG. 2 is an illustration of a cross-section of the activated carbon anode 6. FIG. 2 shows that the activated carbon anode 6 can comprise a current collector 10 having the protective layer 12 located thereon. An active layer 14 can be located on at least one side of the activated carbon anode 6 such that the protective layer 12 is located in between the current collector 10 and the active layer 14. Conversely, the active layer 14 can be in direct physical contact with the current collector 20. Either way though, the active layer is in electrical contact with the current collector. Although not illustrated, it is noted that the cathode 4 can comprise a lead oxide active layer located on a cathode side current collector. The lead carbon battery can also comprise an optional separator located in between the activated carbon anode and the cathode.

The current collector can comprise at least one of copper, nickel, silver, gold, stainless steel, titanium, or aluminum. The current collector can comprise a metalized polymer, for example, at least one of a metalized polyester, a metalized polyimide, a metalized polyolefin, or a metalized vinyl sheet. The current collector can be in the form of a sheet (for example, having a thickness of greater than or equal to 1 millimeter), a foil (for example, having a thickness of less than 1 millimeter, for example, 15 to 25 micrometers), or a mesh (for example, a woven or unwoven metal wire mesh).

The protective layer is optional and, if present, can be in direct physical contact with the current collector with no intervening layers present. The protective layer can cover substantially all of the surface area of the immersed portion of the current collector. For example, the protective layer can over 90 to 100% of the surface area of the current collector that is immersed in the medium. The protective layer can further coat at least a portion of the surface area of the current collector that is not immersed in the medium. The protective layer can be located on both of the broad surfaces of the current collector as well as on the surface of the edges. The protective layer can comprise an electrically conductive filler to maintain the electrical connection between the active layer and the current collector. The electrically conductive filler can comprise at least one of carbon black, graphite, carbon nanotubes, or graphene.

The medium of the lead carbon battery can comprise sulfuric acid, for example, a liquid sulfuric acid. The medium can comprise a gel electrolyte comprising an aqueous sulfuric acid and a thickening agent in an amount sufficient to render the electrolyte a gel. The gel electrolyte can comprise an alkaline earth metal (for example, a silicate, a sulfate, or a phosphate of calcium or strontium. The active layer can be in direct physical contact with the medium.

The lead carbon battery can charge at a high rate as quantified by the C-rate, a metric that is inversely proportional to the time it would take to fully charge at a given current. For example, a 7C charge rate means that the battery can charge in 1/7 hours or in 8.5 minutes. The lead carbon battery comprising the activated carbon anode can have a C-rate of greater than or equal to 5C, or greater than or equal to 7C, or 5 to 10C. This improvement in the charge rate is significant as lead carbon batteries generally have less than a 2C charge rate.

The lead carbon battery can store in excess of 125 milliampere hours of charge per gram of activated carbon in the active layer (mAh/g). This storage capability is achieved over the standard commercial lead carbon battery voltage range of 1 to 2.1 volts per cell.

The lead carbon battery can have a power of greater than 9 kilowatts after a 5 s charge and a 10 s discharge after discharging 2,000 watt hours of energy.

The lead carbon battery can have a capacity retention of over 80%, or over 90% after 5,000 cycles.

In a specific aspect, the lead carbon battery comprises an activated carbon anode comprising an active layer that comprises greater than or equal to 85 weight percent of the activated carbon, 1 to 15 weight percent of a fibrillated poly(vinylidene fluoride); up to 10 weight percent of an electrically conductive filler, wherein the weights are based on the total weight of the active layer, and wherein the active layer has a porosity of 30 to 75 volume percent, or 40 to 75 volume percent, or 50 to 75 volume percent, or 40 to 70 volume percent, based on the total volume of the active layer; a current collector, wherein the active layer is in electrical contact with the current collector; a lead oxide cathode that is in electrical contact with a cathode side current collector; a separator located in between the activated carbon anode and the cathode an acid located in between the activated carbon anode and the cathode; and a casing encapsulating the activated carbon anode, the cathode, and the acid; wherein the lead carbon battery has at least one, preferably all of a power of greater than 9 kilowatts after a 5 s charge and a 10 s discharge after discharging 2,000 watt hours of energy, a capacity retention of over 80%, or over 90% after 10,000 cycles, a C-rate of greater than or equal to 5C, or greater than or equal to 7C, and can store in excess of 125 milliampere hours of charge per gram of activated carbon in the active layer.

The following examples are provided to illustrate the present disclosure. The examples are merely illustrative and are not intended to limit devices made in accordance with the disclosure to the materials, conditions, or process parameters set forth therein.

### EXAMPLES

The following components were used in the examples.

TABLE 1

| Component | Description | Source |
|---|---|---|
| PVDF | Kynar 761, Poly(vinylidene | Arkema USA |
| | fluoride) | |
| Activated | Elite-C or Powdered-S | Calgon Carbon LLC or |
| Carbon | | General Carbon Corporation |

### Example 1: Preparation of an Activated Carbon Anode Using a Phase Inversion Technique

A porous activated carbon (AC)-PVDF anode was prepared using a phase inversion technique using water as the non-solvent. Specifically, 1 gram of PVDF was dissolved in 42.5 grams of acetone to form a 20% solution by mass using a rotor-stator mixer at room temperature (about 23 degrees Celsius (° C.)). It is noted that other mixing devices are considered as well, for example, FlackTek planetary mixers. 19 grams of activated carbon was added to the PVDF mixture. Portions of the solvent mixture were injected into 25 milliliters of water by rapidly squirting the solvent mixture into the water via a pipette and filtering the precipitate until all of the solvent mixture was precipitated. The water was being actively mixed via a stir bar during the injecting. During the phase inversion process acetone quickly diffused out from the AC-PVDF mixture and formed a macroporous AC-PVDF material, where the PVDF fibrillated in the presence of the activated carbon and formed the composition. The filtering was performed by pouring over a coffee filter. The precipitate was dried at 90° C. to remove acetone and water and the precipitate was compressed to form a free-standing, active material layer having a thickness of 2 millimeters. The active material layer was then dried again at 130° C.

Compared to a conventional “mix & cast” method, the phase inversion method had fewer limitations in preparing a thick electrode. The activated carbon anode was then placed onto a lead metal alloy current collector foil and compressed to achieve a porosity of approximately 65 volume percent based on the total volume of the activated carbon anode. The electrode thus formed was tested against a standard commercial lead acid battery cathode and was found to produce greater than 120 mAh/g activated carbon and accepted charge rates in excess of 7 inverse hours (hr⁻¹).

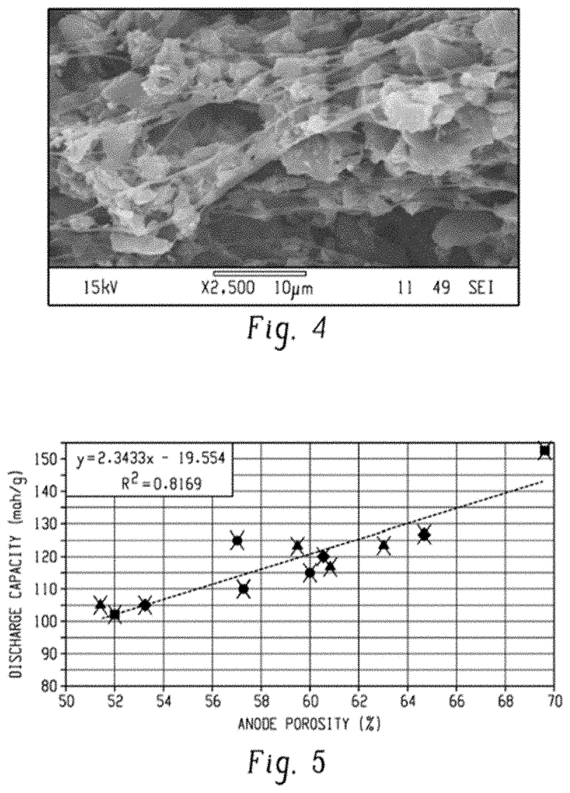

SEM images were taken of two of the filled PVDF layers formed using this method and are shown FIG. 4 and FIG. 5. FIG. 3 is an SEM image of a sample comprising the activated carbon and PVDF in a weight ratio of 95:5. FIG. 4 is an SEM image of a sample comprising carbon black and PVDF in a weight ratio of 85:15 to illustrate that the ratio can be varied and result in the filler having a high surface area exposure in a fibrillated PVDF. FIG. 3 shows that there are small fibrils of PVDF interconnected to the activated carbon particles. FIG. 4 shows that there are larger fibers of PVDF interconnected to the carbon black particles.

### Example 2: Effect of Porosity on the Discharge Capacity

Twelve activated carbon anodes were prepared using the phase inversion method with varying concentration of the PVDF and activated carbon. The porosities and discharge capacities of the activated carbon anodes were determined and the results are illustrated in FIG. 5. In FIG. 5, the samples represented with the diamonds contained 9 wt % of fibrillated poly(vinylidene fluoride) and 91 wt % of the activated carbon; the samples represented with the circles contained 7 wt % of fibrillated poly(vinylidene fluoride) and 93 wt % of the activated carbon; and the samples represented by the triangles contained 5 wt % of fibrillated poly(vinylidene fluoride) and 95 wt % of the activated carbon; and the sample represented by the square illustrates that a porosity of almost 70 volume percent was capable of being prepared. FIG. 5 illustrates that increasing the activated carbon anode porosity resulted in an increase in the discharge capacity.

The discharge curves reveal a low sloping plateau that indicates the presence of Faradic charge storage phenomena. Prior anodes comprising an activated carbon layer describe discharge curves with much higher slopes, indicating a charge separation phenomena as the means of storing charge, which results in less specific capacity over the desired voltage range of 2.1 down to 1 volts for commercial lead acid batteries.

### Examples 3-6: Activated Carbon Electrodes Formed by Other Methods

The layer of Example 3 was formed by mixing PVDF in acetone using an ultrasonic mixer. Activated carbon was added to the solution and mixed to form a solvent mixture comprising having a weight ratio of the activated carbon to the PVDF of 90:10. The solvent mixture was cast onto a polyester film using a drawdown bar with a gap height of 3 to 4 millimeters. The mixture was dried in air at room temperature and a 25 mm circular die was used to cut the sample and form the layer of Example 3. The layer of Example 3 produced a fractured, brittle sample that could not be tested.

The layer of Examples 4-6 was formed by mixing PVDF in acetone using an ultrasonic mixer. Activated carbon was added to the solution and mixed to form a solvent mixture comprising having a weight ratio of the activated carbon to the PVDF of 80:20 for Example 4, 90:10 for Example 5, and 95:5 for Example 6. The solvent mixture was put in a mold having a diameter of 25 mm. The solvent mixture was allowed to dry by heating at 100° C. for 5 minutes and then at room temperature for 15 minutes. The dried sample was compressed with 200 pounds of force in a Carver Press to exert a pressure of 1,750 kilopascals. The sample was removed from the mold to form the layers of Examples 4-6. Neither of the layers of Examples 5 or 6 having the increased amount of PVDF resulted in coherent samples.

### Examples 7-8: Comparison Testing of an Activated Carbon Anode to a Commercial Anode

The lead carbon battery of Example 7 was a commercial AGM (Absorbent glass mat) lead acid battery having a PbO₂ positive active material and an anode with a separator in between to physically isolate the electrodes. The lead carbon battery of Example 8 was the same as that of Example 7 except that the anode was prepared in accordance with Example 1.

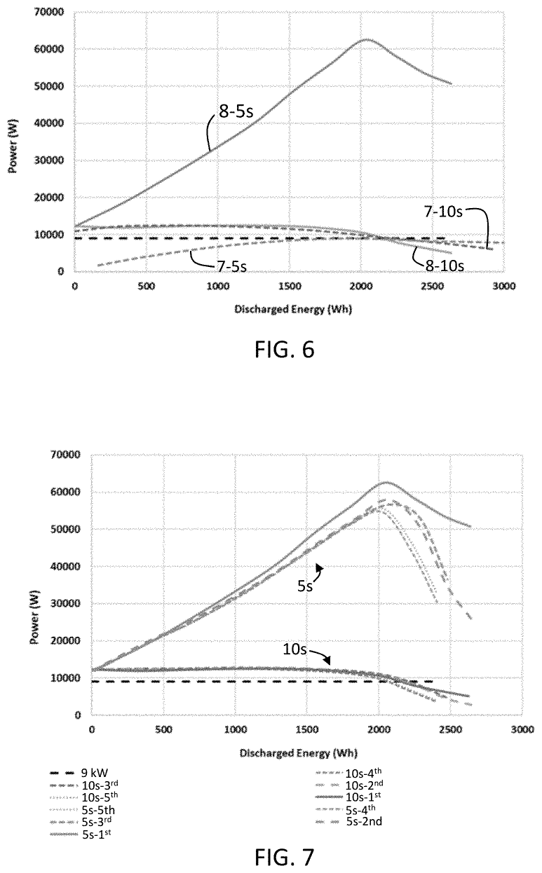

The dynamic charge acceptance (DCA) of the batteries of Examples 7 and 8 were tested and the results are shown in FIG. 6, where the horizontal line in the graph is the 9 kilowatt power goal. The testing is performed in accordance to United States Advanced Battery Consortium Battery Test Manual For 48 Volt Mild Hybrid Electrical Vehicles (Revision 0 March 2017 Version) (USABC). In FIG. 6, power in watts (W) for the 5 s and 10 s charge and discharge curves of Example 7 (7-5 s and 7-10 s) and Example 8 (8-5 s and 8-10 s), respectively, are shown as a function of discharged energy in watt hours (Wh). FIG. 6 shows that while the batteries of Example 7 and Example 8 show discharge power, there is a significant improvement in the 5 s charge power of the battery of Example 8, where the power at 2,000 Wh is over 5 times that of Example 7.

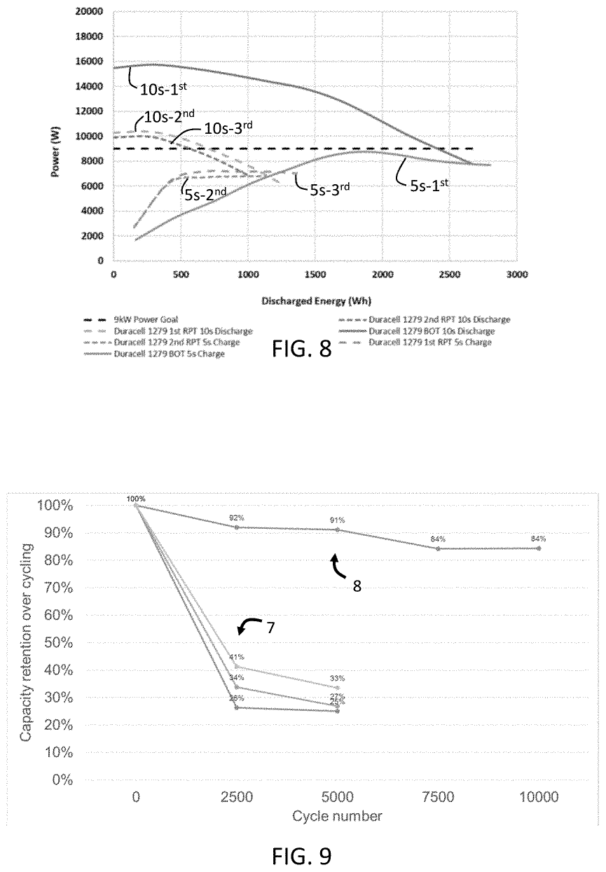

The dynamic charge acceptance was further tested on the batteries of Example 7 and Example 8 after every 2,500 partial state of charge cycles and the results are shown in FIG. 8 and FIG. 7, respectively. The cycles are indicated in the figures by a 5 s or a 10 s for charge and discharge, respectively, followed by the repeat number (multiply 2,500 to get the cycle number). The horizontal line in FIG. 7 and FIG. 8 show the 9 kilowatt power goal according to USABC. Comparing FIG. 7 to FIG. 8, a significant improvement in the power retention over long term cycling is observed. Moreover, it is seen that the battery of Example 8 was able to consistently surpass the 9,000 kilowatt power goal.

The partial state of charge (PSoC) with cycling was measured for three different batteries of Example 7 and compared to that of a battery of Example 8. The testing method is defined in the USABC. The results are shown in FIG. 9. FIG. 9 shows that the battery of Example 8 was able to maintain over 90% of its capacity retention after 5,000 cycles and over 84% after 10,000 cycles. These results are significantly improved relative to the only 26 to 41% capacity retention of the batteries of Example 7 after only 2,500 cycles.

Set forth below are non-limiting aspects of the present disclosure.

Aspect 1: A method of making an active layer for an activated carbon anode in a lead carbon battery comprising: forming a solvent mixture comprising poly(vinylidene fluoride) and a solvent; combining the solvent mixture with a non-solvent to form a precipitate comprising the activated carbon in a fibrillated poly(vinylidene fluoride) matrix; wherein at least one of the solvent mixture and the non-solvent comprises the activated carbon or an optional electrically conductive filler; separating the precipitate from the solvent and the non-solvent; and forming the active layer from the precipitate. The active layer comprises greater than or equal to 85 weight percent of the activated carbon; 1 to 15 weight percent of the fibrillated poly(vinylidene fluoride); and 0 to 10 weight percent of an electrically conductive filler; wherein the weights are based on the total weight of the active layer.

Aspect 2: The method of Aspect 1, wherein the solvent has at least one Hansen solubility parameter of 15≤δ_{d}≤20 MPa^{1/2}, or 16≤δ_{d}≤18.5 MPa^{1/2}; 5≤δₚ≤18 MPa^{1/2}, or 8.5≤δₚ≤16.5 MPa^{1/2}; or 4≤δₕ≤12 MPa^{1/2}, or 5≤δₕ≤11.5 MPa^{1/2}.

Aspect 3: The method of any one or more of the preceding aspects, wherein the solvent comprises at least one of acetone, cyclohexanone, dimethylacetamide (DMAc), methyl ethyl ketone, N,N-dimethylformamide (DMF), dimethyl sulfoxide (DMSO), N-methylpyrrolidone (NMP), tetrahydrofuran (THF), tetramethyl urea, or trimethyl phosphate. Preferably, the solvent comprises at least one of dimethylacetamide (DMAc), methyl ethyl ketone, N,N-dimethylformamide (DMF), N-methylpyrrolidone (NMP), or dimethyl sulfoxide (DMSO).

Aspect 4: The method of any one or more of the preceding aspects, wherein the non-solvent has at least one Hansen solubility parameter of 12≤δ_{d}≤14.9 MPa^{1/2}; 0≤δₚ≤8 MPa^{1/2}, or 1≤δₚ≤4.9 MPa^{1/2}; or 13≤δₕ≤50 MPa^{1/2}, or 15≤δₕ≤45 MPa^{1/2}.

Aspect 5: The method of any one or more of the preceding aspects, wherein the non-solvent comprises at least one of an acid solution, an alcohol (for example, an alkyl alcohol), an aliphatic hydrocarbon, an aromatic hydrocarbon, a basic solution, butyrolactone, N-butyl acetate, carbitol acetate, diisobutyl ketone, dimethyl phthalate, ethyl acetoacetate, a glycol ether, a glycol ether ester, glyceryl triacetate, a halogenated solvent, isophorone, methyl isobutyl ketone, propylene carbonate, triethyl phosphate, or water.

Aspect 6: The method of any one or more of the preceding aspects, wherein the combining the solvent mixture with the non-solvent comprises pouring or injecting the solvent mixture into the non-solvent.

Aspect 7: The method of any one or more of the preceding aspects, wherein the combining the solvent mixture with the non-solvent does not comprise actively mixing the solvent mixture with the non-solvent.

Aspect 8: The method of any one or more of the preceding aspects, wherein the separating the precipitate comprises at least one of draining, filtering, or centrifuging the solvent and the non-solvent from the precipitate.

Aspect 9: The method of any one or more of the preceding aspects, further comprising drying at least one of the precipitate or the active layer.

Aspect 10: The method of any one or more of the preceding aspects, wherein the electrically conductive filler is present and comprises at least one of graphite, carbon nanotubes, carbon fibers, graphene, or carbon black.

Aspect 11: The method of any one or more of the preceding aspects, wherein the forming the active layer comprises at least one of extruding, molding, casting, thermoforming, calendering, laminating, or roll coating the active layer.

Aspect 12: The method of any one or more of the preceding aspects, wherein the poly(vinylidene fluoride) comprises a poly(vinylidene fluoride) copolymer, for example a poly(vinylidene fluoride) copolymer with chlorotrifluoroethylene.

Aspect 13: The method of any one or more of the preceding aspects, wherein the activated carbon has a surface area of greater than or equal to 500 m²/g, or greater than or equal to 1,500 m²/g.

Aspect 14: An active layer comprising greater than or equal to 85 weight percent of the activated carbon; 1 to 15 weight percent of the fibrillated poly(vinylidene fluoride); and 0 to 10 weight percent of an electrically conductive filler; wherein the weights are based on the total weight of the active layer; wherein the active layer is optionally formed by the method of any one or more of the preceding aspects.

Aspect 15: The active layer of the preceding aspect, wherein the active layer has at least one of a porosity of 30 to 75 volume percent, or 40 to 75 volume percent, or 50 to 75 volume percent, or 40 to 70 volume percent; or a thickness of 0.5 to 10 millimeters, or 2.5 to 5 millimeters; or wherein the active layer is free standing.

Aspect 16: A lead carbon battery comprising an activated carbon anode comprising an active layer, optionally the active layer of Aspect 14 or Aspect 15, and a current collector, wherein the active layer is in electrical contact with the current collector; a lead oxide cathode that is in electrical contact with a cathode side current collector; an acid (for example, sulfuric acid) located in between the activated carbon anode and the cathode; and a casing encapsulating the activated carbon anode, the cathode, and the acid.

Aspect 17: A lead carbon battery comprising an activated carbon anode comprising an active layer; a current collector, wherein the active layer is in electrical contact with the current collector; a lead oxide cathode that is in electrical contact with a cathode side current collector; an acid located in between the activated carbon anode and the cathode; and a casing encapsulating the activated carbon anode, the cathode, and the acid; wherein the active layer comprises greater than or equal to 85 weight percent of the activated carbon; 1 to 15 weight percent of the fibrillated poly(vinylidene fluoride); and 0 to 10 weight percent of an electrically conductive filler; wherein the weights are based on the total weight of the active layer; wherein the active layer has a porosity of 30 to 75 volume percent.

Aspect 18: The lead carbon battery of Aspect 16 or Aspect 17, wherein the lead carbon battery has at least one of a power of greater than 9 kilowatts after a 5 s charge and a 10 s discharge after discharging 2,000 watt hours of energy; or a capacity retention of over 90% after 5,000 cycles or over 80% after 10,000 cycles; as determined in accordance to United States Advanced Battery Consortium Battery Test Manual For 48 Volt Mild Hybrid Electrical Vehicles (Revision 0 March 2017 Version).

Aspect 19: The lead carbon battery of any one or more of Aspects 16 to 18, wherein the active layer is in direct physical contact with the current collector.

Aspect 20: The lead carbon battery of any one or more of Aspects 16 to 19, wherein the active layer is in direct physical contact with the acid.

Aspect 21: The lead carbon battery of any one or more of Aspects 16 to 20, further comprising a separator located in between the activated carbon anode and the cathode.

Aspect 22: The lead carbon battery of any one or more of Aspects 16 to 21, wherein the lead carbon battery has a C-rate of greater than or equal to 5C, or greater than or equal to 7C; or wherein the lead carbon battery can store in excess of 125 milliampere hours of charge per gram of activated carbon in the active layer. This storage capability is achieved over the standard commercial lead carbon battery voltage range of 1 to 2.1 volts per cell.

Aspect 23: The lead carbon battery of any one or more of Aspects 16 to 22, wherein the electrically conductive filler is present and comprises at least one of graphite, carbon nanotubes, carbon fibers, graphene, or carbon black.

Aspect 24: The lead carbon battery of any one or more of Aspects 16 to 23, wherein the poly(vinylidene fluoride) comprises a poly(vinylidene fluoride) copolymer or a poly(vinylidene fluoride) copolymer with chlorotrifluoroethylene.

Aspect 25: The lead carbon battery of any one or more of Aspects 16 to 24, wherein the activated carbon has a surface area of greater than or equal to 500 m²/g, or greater than or equal to 1,500 m²/g.

Aspect 26: The lead carbon battery of any one or more of Aspects 16 to 25, wherein the active layer has a thickness of 0.5 to 10 millimeters, or 2.5 to 5 millimeters.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context. Reference throughout the specification to “an aspect”, “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.). The term “combination thereof” or “at least one of” means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A lead carbon battery comprising:
an activated carbon anode comprising an active layer;
a current collector, wherein the active layer is in electrical contact with the current collector;
a lead oxide cathode that is in electrical contact with a cathode side current collector;
an acid located in between the activated carbon anode and the cathode; and
a casing encapsulating the activated carbon anode, the cathode, and the acid;
wherein the active layer comprises
greater than or equal to 85 weight percent of the activated carbon;
1 to 15 weight percent of a fibrillated poly(vinylidene fluoride); and
0 to 10 weight percent of an electrically conductive filler;
wherein the weights are based on the total weight of the active layer;
wherein the active layer has a porosity of 30 to 75 volume percent based on the total volume of the active layer.

2. The lead carbon battery of claim 1, wherein the lead carbon battery has a power of greater than 9 kilowatts after a 5 s charge and a 10 s discharge after discharging 2,000 watt hours of energy.

3. The lead carbon battery of claim 1, wherein the lead carbon battery has a capacity retention of over 90% after 5,000 cycles.

4. The lead carbon battery of claim 1, wherein the lead carbon battery has a capacity retention of over 80% after 10,000 cycles.

5. The lead carbon battery of claim 1, wherein the lead carbon battery has a C-rate of greater than or equal to 5C.

6. The lead carbon battery of claim 1, wherein the lead carbon battery can store in excess of 125 milliampere hours of charge per gram of activated carbon in the active layer.

7. The lead carbon battery of claim 1, wherein the electrically conductive filler is present and comprises at least one of graphite, carbon nanotubes, carbon fibers, graphene, or carbon black.

8. The lead carbon battery of claim 1, wherein the poly(vinylidene fluoride) comprises a poly(vinylidene fluoride) copolymer or a poly(vinylidene fluoride) copolymer with chlorotrifluoroethylene.

9. The lead carbon battery of claim 1, wherein the activated carbon has a surface area of greater than or equal to 500 m²/g.

10. The lead carbon battery of claim 1, wherein the active layer has a thickness of 0.5 to 10 millimeters.

11. The lead carbon battery of claim 1, wherein the active layer is in direct physical contact with the current collector.

12. The lead carbon battery of claim 1, wherein the active layer is in direct physical contact with the acid.

13. The lead carbon battery of claim 1, further comprising a separator located in between the activated carbon anode and the cathode.

14. The lead carbon battery of claim 1, wherein the active layer has a porosity of 50 to 75 volume percent based on the total volume of the active layer.

15. A lead carbon battery comprising:
an activated carbon anode comprising an active layer; wherein the active layer has a thickness of 0.5 to 10 millimeters;
a current collector, wherein the active layer is in electrical contact and is in direct physical contact with the current collector;
a lead oxide cathode that is in electrical contact with a cathode side current collector;
an acid located in between the activated carbon anode and the cathode; wherein the active layer is in direct physical contact with the acid; and
a casing encapsulating the activated carbon anode, the cathode, and the acid;
wherein the active layer comprises
greater than or equal to 85 weight percent of the activated carbon; wherein the activated carbon has a surface area of greater than or equal to 500 m²/g;
1 to 15 weight percent of the fibrillated poly(vinylidene fluoride); and
0 to 10 weight percent of an electrically conductive filler;
wherein the weights are based on the total weight of the active layer;
wherein the active layer has a porosity of 50 to 75 volume percent based on the total volume of the active layer;
wherein the lead carbon battery has at least one of
a power of greater than 9 kilowatts after a 5 s charge and a 10 s discharge after discharging 2,000 watt hours of energy;
a capacity retention of over 90% after 5,000 cycles;
a capacity retention of over 80% after 10,000 cycles;
a C-rate of greater than or equal to 5C; or
wherein the lead carbon battery can store in excess of 125 milliampere hours of charge per gram of activated carbon in the active layer.
